(19) United States
(12) Patent Application Publication
(10) Pub. No.: US 2009/0085846 A1
(43) Pub. Date: Apr. 2, 2009

(54) IMAGE PROCESSING DEVICE AND METHOD PERFORMING MOTION COMPENSATION USING MOTION ESTIMATION

(75) Inventors: Hwa Hyun CHO, Seoul (KR); Jong Seon KIM, Seongnam-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: Samsung Electronics Co., Ltd., Suwon-si (KR)

(21) Appl. No.: 12/210,366

(22) Filed: Sep. 15, 2008

(30) Foreign Application Priority Data
Sep. 27, 2007 (KR) 10-2007-0097318

(51) Int. Cl. H04N 11/02; G09G 3/36

(52) U.S. Cl. 345/87; 375/240.16

(57) ABSTRACT

An image processing device is provided. The image processing device includes a calculator and a controller. The calculator performs a block matching algorithm based on a difference between first image data of a macroblock and second image data of each of a plurality of blocks in a search range. The controller generates a motion vector used for motion compensation based on a result of the block matching algorithm and alternately changes a scan direction of the second image data at an interval of one horizontal period in a frame. The image processing device shares the second image data, which is repeatedly used during the block matching algorithm, in a horizontal direction.

### CROSS-REFERENCE TO RELATED PATENT APPLICATION

This application claims the benefit of Korean Patent Application No. 10-2007-0097318 filed on Sep. 27, 2007, the subject matter of which is hereby incorporated by reference.

### BACKGROUND

The present invention relates to an image processing device and method. More particularly, the invention relates to an image processing device and method increasing image processing speed by minimizing memory update for a search range through data sharing during motion estimation and by simultaneously performing search and memory update.

Video images are generally processed on a frame by frame basis. A video frame may be considered a visual snap-shot in time, so to speak. From moment to moment, as the visual content of a particular video changes, the data making up the corresponding frames must be changed or updated. The process of calculating the change between temporally successive frames is commonly referred to as temporal prediction and is usually performed by a conventionally process known as motion compensation. Motion compensation may be performed in several different ways. For example, motion compensation may be performed after a process known as motion estimation. Motion estimation is a process whereby corresponding pixels in related frames are identified.

Motion compensation may be viewed as a process whereby objects moving across a sequence of related frames may be accounted for during formation of the related frames. For example, an object's trace across related frames is tracked by a motion compensation process in order to reduce (or minimize) differences (e.g., visual discontinuities) between successive frames. However, tracking various image pixels associated with object(s) from frame to frame during motion compensation requires a relatively large number of mathematical calculations; otherwise the tracked path may not be accurate because of the noise characteristics that exist in relation to each frame. For these reasons, individual pixel paths are not tracked. Rather a grouping of pixels (e.g., object related pixels) is associated with a macroblock, and a motion vector is then generated to facilitate tracking of the macroblock's path. This method is commonly referred to as block matching algorithm. The block matching algorithm is simple but not highly accurate in its motion prediction and estimation capabilities. However, it is easy to implement in hardware and is thus widely used in motion compensation circuits.

### SUMMARY

Embodiments of the invention provide an image processing device that increases image processing speed. This improvement is enabled by sharing data, minimizing a search range memory update, and/or simultaneously performing a sum absolute difference (SAD) operation and memory update. Embodiments of the invention may include an operation unit having a pipe line structure capable of being extended in both horizontal and vertical directions. Embodiments of the invention also provide corresponding image processing methods using this type of image processing device.

According to some embodiments of the present invention, there is provided an image processing device including a calculator and a controller. The calculator performs a block matching algorithm based on a difference between first image data of a macroblock and second image data of each of a plurality of blocks in a search range. The controller generates a motion vector used for motion compensation based on a result of the block matching algorithm and alternately changes a scan direction of the second image data at an interval of one horizontal period in a frame.

The image processing device may further include a memory controller, a first memory, and a second memory. The memory controller generates a first control signal and a second control signal in response to a motion estimation enable signal received from the controller. The first memory buffers the first image data received from a video memory in response to the first control signal. The second memory buffers the second image data received from the video memory in response to the second control signal.

The controller may divide the second memory into a plurality of sub-memories having a predetermined size and sequentially update the second image data with respect to the plurality of sub-memories. The controller may divide the search range into a plurality of sub-ranges having a predetermined size and scan the second image data in each sub-range in a direction perpendicular to the scan direction of the second image data in the frame.

The controller may update at least one sub-memory of the second memory corresponding to a sub-range, in which the second image data has been scanned completely, among the plurality of sub-ranges and simultaneously perform the block matching algorithm with respect to a subsequent sub-range among the plurality of sub-ranges.

According to other embodiments of the present invention, there is provided an image processing method including performing a block matching algorithm based on a difference between first image data of a macroblock and second image data of each of a plurality of blocks in a search range; and generating a motion vector used for motion compensation based on a result of the block matching algorithm and alternately changing a scan direction of the second image data at an interval of one horizontal period in a frame.

The image processing method may further include generating a first control signal and a second control signal in response to a motion estimation enable signal, buffering the first image data received from a video memory in response to the first control signal, and buffering the second image data received from the video memory in response to the second control signal.

The buffering the second image data may include dividing a second memory buffering the second image data into a plurality of sub-memories having a predetermined size and sequentially updating the second image data with respect to the plurality of sub-memories.

The buffering the second image data may further include dividing the search range into a plurality of sub-ranges having a predetermined size and scanning the second image data in each sub-range in a direction perpendicular to the scan direction of the second image data in the frame.

The image processing method may further include updating at least one sub-memory of the second memory corresponding to a sub-range, in which the second image data has been scanned completely, among the plurality of sub-ranges and simultaneously performing the block matching algorithm with respect to a subsequent sub-range among the plurality of sub-ranges.

### BRIEF DESCRIPTION OF THE DRAWINGS

FIG. 1 illustrates motion estimation in a search range of a previous frame with respect to a macroblock in a current frame;

FIG. 2 illustrates a macroblock and a search range used in motion estimation;

FIG. 3 illustrates an image processing device according to an embodiment of the invention;

FIG. 4 illustrates the structure of a second memory for sharing second image data in a horizontal direction according to an embodiment of the invention;

FIG. 5 illustrates a scan direction of the second image data in a frame according to an embodiment of the invention;

FIG. 6A illustrates the update of the second memory when the second image data is scanned from left to right according to an embodiment of the invention;

FIG. 6B illustrates the update of the second memory when the second image data is scanned from up to down according to an embodiment of the invention;

FIG. 6C illustrates the update of the second memory when the second image data is scanned from right to left according to an embodiment of the invention;

FIG. 7A illustrates a scan direction for a conventional image processing device and a scan direction for an image processing device according to an embodiment of the invention for the second image data in a search range;

FIG. 7B illustrates a scan direction of the second image data when a search range is divided into three sub-ranges according to an embodiment of the invention;

FIG. 8 illustrates the pipe line structure of an operation unit included in an operation unit block performing a sum absolute difference (SAD) operation with respect to a 16×8 macroblock according to an embodiment of the invention;

FIG. 9 illustrates a comparison unit included in the image processing device illustrated in FIG. 3;

FIG. 10 is a conceptual diagram of a method of sharing data in a horizontal direction using an operation unit block including 16 operation units according to an embodiment of the invention;

FIGS. 11A and 11B are block diagrams of a display device using an image processing device according to an embodiment of the invention;

FIG. 12 is a flowchart of a method of performing a block matching algorithm with respect to an entire predetermined search range using an image processing device according to an embodiment of the invention; and

FIG. 13 is a flowchart of a method of performing SAD operation with respect to a plurality of blocks in a search range using an image processing device according to an embodiment of the invention.

### DESCRIPTION OF EMBODIMENTS

The present invention now will be described in some additional details with reference to the accompanying drawings. The invention may, however, be embodied in many different forms and should not be construed as being limited to only the illustrated embodiments. Rather, these embodiments are presented as teaching examples. Throughout the drawings and written description like numbers and indications are used to refer to like or similar elements.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein, the term “and/or” includes any and all combinations of one or more of the associated listed items and may be abbreviated as “/”.

It will be understood that, although the terms first, second, etc. may be used herein to describe various elements, these elements should not be limited by these terms. These terms are only used to distinguish one element from another. For example, a first signal could be termed a second signal, and, similarly, a second signal could be termed a first signal without departing from the teachings of the disclosure.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and/or the present application, and will not be interpreted in an idealized or overly formal sense unless expressly so defined herein.

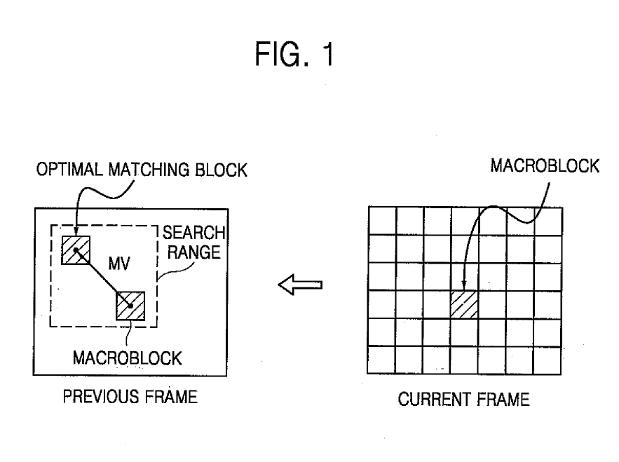

FIG. 1 illustrates motion estimation in a search range for a previous frame with respect to a macroblock in a current frame. It is assumed in the illustrated example that the subsequent frame as well as the previous and current frames are used for the motion estimation. A grouping of pixels (or pixel block) which is a target of the motion estimation process in the current frame is identified with a macroblock that includes M×N pixels, where M and N are natural numbers greater than 1. The search range is a range in which a block most similar to the macroblock is searched in the previous frame. A difference between a position value of the macroblock in the current frame and a position value of the most similar block (or an optimal matching block) in the previous frame is a motion vector (MV).

In order to estimate a block, i.e., an optimal matching block most similar to a macroblock in a search range, a matching method such as the conventionally understood mean square error (MSE) operation, mean absolute error (MAE) operation, or sum absolute difference (SAD) operation may be used as suggested by the following Equation (1), (2), or (3):

$$\begin{matrix}MSE ( dx , dy ) = \frac{1}{N \times N} {\sum }_{m = x}^{x + N - 1} {\sum }_{n = y}^{y + N - 1} {[ {f}_{k} ( m , n ) - {f}_{k - 1} ( m + dx , n + dy ) ]}^{2} \\ ( MVx , MVy ) = {min}_{( dx , dy )} MSE ( dx , dy ) & ( Equation 1 ) \\ MAE ( dx , dy ) = \frac{1}{N \times N} {\sum }_{m = x}^{x + N - 1} {\sum }_{n = y}^{y + N - 1} [ {f}_{k} ( m , n ) - {f}_{k - 1} ( m + dx , n + dy ) ] \\ ( MVx , MVy ) = {min}_{( dx , dy )} MAE ( dx , dy ) & ( Equation 2 ) \\ SAD ( dx , dy ) = {\sum }_{m = x}^{x + N - 1} {\sum }_{n = y}^{y + N - 1} [ {f}_{k} ( m , n ) - {f}_{k - 1} ( m + dx , n + dy ) ] \\ ( MVx , MVy ) = {min}_{( dx , dy )} SAD ( dx , dy ) & ( Equation 3 )\end{matrix}$$

In the foregoing equations, N is the size of the macroblock (formed by N×N pixels), “m” and “n” are the x and y coordinates of a pixel in a current frame, “k” and “k−1” respectively indicate the present frame and a previous frame, and “dx” and “dy” indicate a difference in a position between the macroblock of the current frame and the optimal matching block of the previous frame, where N, “m”, “n”, and “k” are natural numbers greater than 1.

Hereinafter, image processing devices and methods in which motion estimation is performed using the SAD operation will be described. This particular method requires a relatively small number of constituent calculations and is relatively easy to implement in hardware. However, the scope of the present invention is not restricted to only embodiments using the SAD operation. Rather, those skilled in the art will understand that MSE method, the MAD method or similar calculation methods might alternately be used to perform motion estimation.

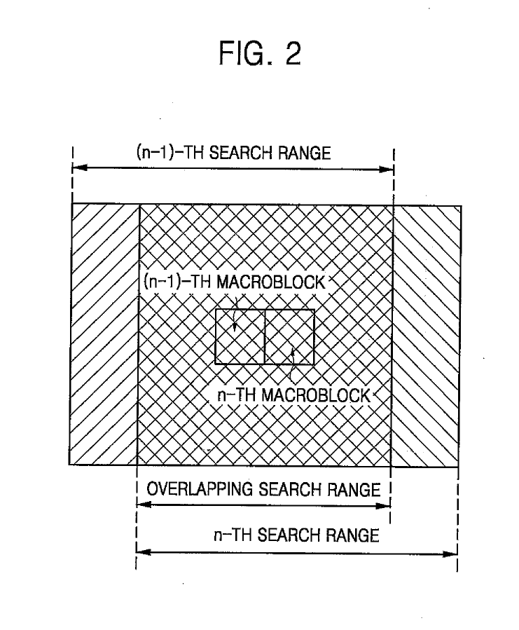

FIG. 2 illustrates a macroblock and a corresponding search range used for motion estimation. Referring to FIG. 2, an (n−1)-th search range for an (n−1)-th macroblock overlaps with an n-th search range for an n-th macroblock.

As noted above, motion estimation is a process that generally requires the greatest number of calculations during image processing. The data used for motion estimation between adjacent macroblocks are the same in a large portion. In addition, since the SAD operation operator is fixed according to a defined search range, extensibility is limited.

Therefore, a technique of sharing repeatedly used data to reduce image processing time and a SAD operation operator which may be extended according to a corresponding search range are advantageously incorporated into certain embodiments of the invention.

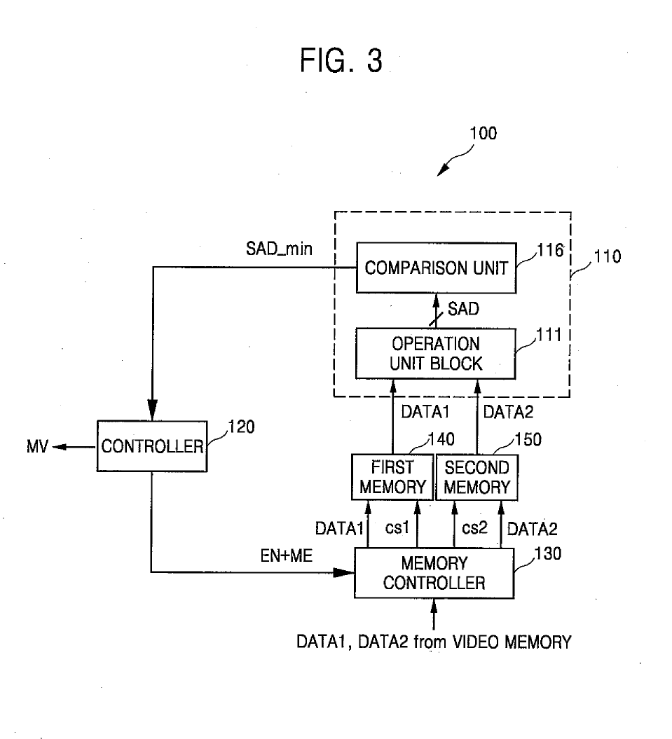

FIG. 3 illustrates an image processing device 100 according to an embodiment of the invention. The image processing device 100 includes a calculator 110 and a controller 120. The calculator 110 performs a block matching algorithm with respect to first image data DATAL from a macroblock and second image data DATA2 from respective blocks in a search range and outputs a block matching result SAD_min. The controller 120 generates a motion vector (MV) used to perform motion compensation based on the block matching result SAD_min and alternately changes a scan direction for the second image data DATA2 at a defined interval (e.g., one horizontal period for the frame).

The image processing device 100 further includes a memory controller 130, a first memory 140, and a second memory 150. The memory controller 130 generates a first control signal CS1 and a second control signal CS2 in response to a motion estimation enable signal EN_ME received from the controller 120. The first memory 140 buffers the first image data DATAL received from a video memory (not shown) in response to the first control signal CS1. The second memory 150 buffers the second image data DATA2 received from the video memory in response to the second control signal CS2.

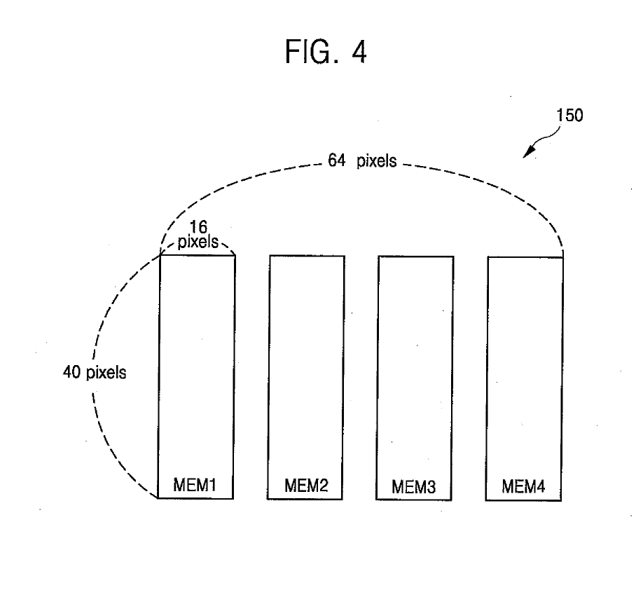

FIG. 4 illustrates the structure of the second memory 150 for sharing the second image data DATA2 in a horizontal direction according to some embodiments of the present invention. Referring to FIG. 4, when the search range is 64×40 pixels in size, the second memory 150 may include a plurality of sub-memories MEM1, MEM2, MEM3, and MEM4 each of which can buffer (e.g.,) 16×40 pixels of the second image data DATA2.

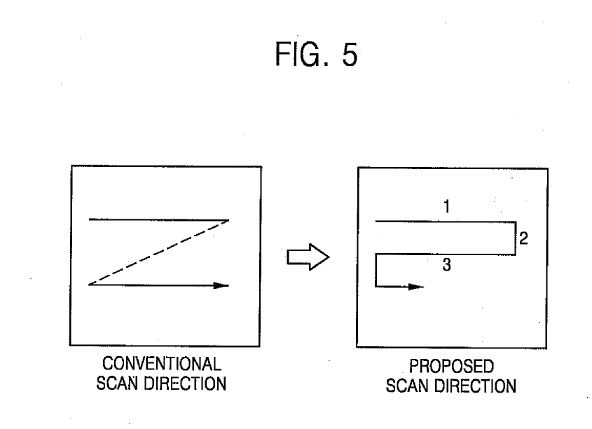

FIG. 5 illustrates a scan direction for the second image data DATA2 in relation to a frame according to an embodiment of the invention. Referring to FIG. 5, a conventional image processing device (shown for comparative purposes) scans the second image data DATA2 in a single fixed direction (i.e., from left to right across a frame), while the image processing device 100 according to an embodiment of the invention is capable of scanning the second image data DATA2 in multiple directions that change according to a defined interval (e.g., an interval of one horizontal period).

In some additional detail, the controller 120 outputs the motion estimation enable signal EN_ME. The memory controller 130 generates the second control signal CS2 in response to the motion estimation enable signal EN_ME. The second memory 150 buffers the second image data DATA2 in response to the second control signal CS2 so that the horizontal scan direction of the second image data DATA2 changes at an interval of one horizontal period. Consequently, the controller 120 changes the horizontal scan direction of the second image data DATA2 at an interval of one horizontal period in a frame using the motion estimation enable signal EN_ME.

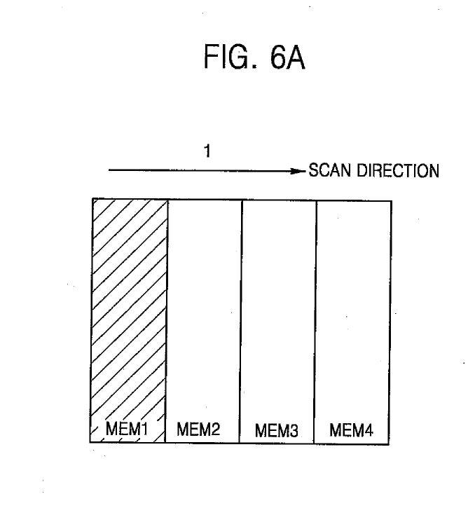

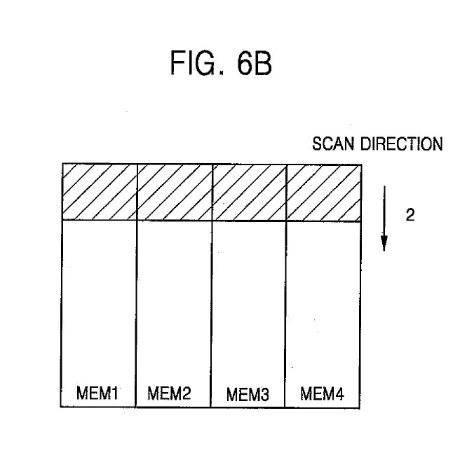

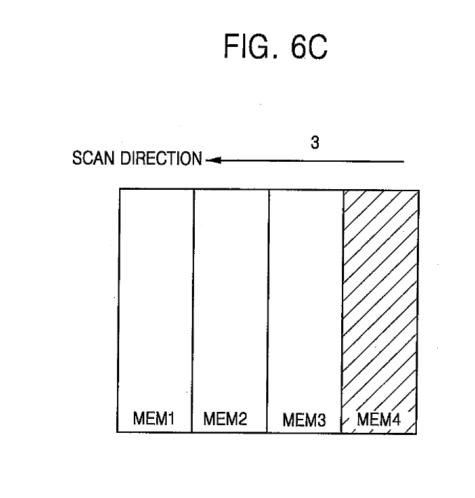

FIG. 6A illustrates the update of the second memory 150 when the second image data DATA2 is scanned from left to right (i.e., a first direction (1)) according to the illustrated embodiment of the invention. FIG. 6B illustrates the update of the second memory 150 when the second image data DATA2 is scanned from up to down (i.e., a second direction (2)). FIG. 6C illustrates the update of the second memory 150 when the second image data DATA2 is scanned from right to left (i.e., a third direction (3)).

In FIGS. 6A through 6C, the cross-hatched portions are the memory portions that can be updated in relation to the multiple scan directions. In a conventional image processing device, it is necessary to update an entire search range when the last block in the horizontal direction is updated with the first block on a subsequent line. However, in the image processing device 100 according to embodiments of the invention, at least one quarter (the hatched portion) of the second memory 150 is always available for update according to any one of the multiple scan directions for the second image data DATA2. Since the second memory 150 is divided into the sub-memories MEM1, MEM2, MEM3, and MEM4 when the block matching algorithm is performed, a certain portion of the second memory 150 can always be updated without memory for the entire search range necessarily being updated. Accordingly, embodiments of the invention increase the efficiency of memory use.

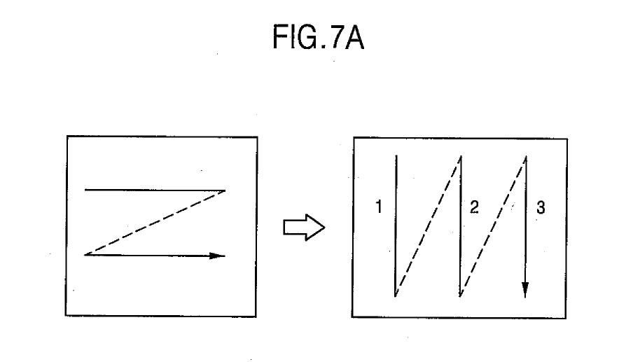

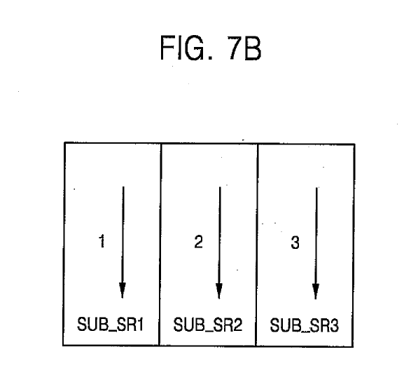

FIG. 7A illustrates a horizontal (left to right) scan direction for a conventional image processing device in comparison with a vertical (top to bottom) scan direction for the image processing device 100 according to an embodiment of the invention. Here again, these scan directions are identified in relation to the second image data DATA2 in a search range. FIG. 7B further illustrates the vertical scan direction of the second image data DATA2 when the search range is divided into a plurality of sub-ranges SUB_SR1, SUB_SR2, and SUB_SR3 according to embodiments of the invention. In this context, the term horizontal has meaning in relation to the normal horizontal raster scanning direction associated with the generation and reading of image data. Thus, a horizontal scanning direction may be associated with a row-wise scanning progression in relation to image data generated in a similar row-wise raster scanning approach.

In contrast and referring to FIGS. 7A and 7B, the second image data DATA2 is scanned in the vertical direction (from top to bottom, or from bottom to top) in the sub-ranges SUB_SR1, SUB_SR2, and SUB_SR3. In other words, the vertical scan direction of the second image data DATA2 in the sub-ranges SUB_SR1, SUB_SR2, and SUB_SR3 of the search range is orthogonal to the horizontal scan direction of the second image data DATA2 in a frame. The resulting scan pattern for the second image data DATA2 among the sub-ranges SUB_SR1, SUB_SR2, and SUB_SR3 is a vertical zigzag.

The controller 120 may control the memory controller 130 so that the second memory 150 sequentially buffers the second image data DATA2 corresponding to the sub-ranges SUB_SR1, SUB_SR2, and SUB_SR3. At this time, the block matching algorithm is subsequently performed with respect to the sub-ranges SUB_SR1, SUB_SR2, and SUB_SR3 in the search range. The controller 120 may control the memory controller 130 to subsequently update the second image data DATA2 with respect to a sub-range that has undergone the block matching algorithm among the sub-ranges SUB_SR1, SUB_SR2, and SUB_SR3. In addition, the controller 120 may control the memory controller 130 to simultaneously perform the update of the second image data DATA2 with respect to a sub-range undergone the block matching algorithm and the block matching algorithm with respect to a subsequent sub-range.

Table 1 below shows sub-memories for the second memory 150, which are used when the SAD operation is performed with respect to a high definition (HD) or full HD image, and a sub-memory which is updated at that time.

TABLE 1

| | | Memory | Used sub- | Updated sub- |
|---|---|---|---|---|
| Pattern | Macroblock | count | memories | memory |
| First | First macroblock | 0 | 1, 2 | |
| pattern | | 1 | 2, 3 | |
| | | 2 | 3, 4 | |
| | Second | 3 | 2, 3 | 1 |
| | macroblock | 4 | 3, 4 | |
| | | 5 | 4, 1 | |
| | Third macroblock | 6 | 3, 4 | 2 |
| | | 7 | 4, 1 | |
| | | 8 | 1, 2 | |
| | Fourth macroblock | 9 | 4, 1 | 3 |
| | | 10 | 1, 2 | |
| | | 11 | 2, 3 | |
| Second | First macroblock | 0 | 1, 2 | 4 |
| pattern | | 1 | 2, 3 | |
| | | 2 | 3, 4 | |
| | Second | 3 | 2, 3 | 1 |
| | macroblock | | | |

Referring to Table 1, the image processing device 100 divides a frame into a plurality of patterns including four macroblocks, i.e., first through fourth macroblocks and performs the SAD operation. To perform the SAD operation on a pattern, a memory count is required (i.e., a count in the illustrated example of from 0 to 11).

The SAD operation is performed on each of three portions into which each macroblock is divided. When the SAD operation is performed on each portion of the macroblock, two sub-memories among the four sub-memories MEM1, MEM2, MEM3, and MEM4 of the second memory 150 are used. Numbers 1 through 4 indicating sub-memories in Table 1 correspond to MEM1, MEM2, MEM3, and MEM4, respectively. Here, a sub-memory of the second memory 150, which is used in the SAD operation of a previous portion of the macroblock, is repeatedly used in the SAD operation of a current portion of the macroblock, which means that the second image data DATA2 is shared in the horizontal direction

A number indicating a sub-memory that is used first for the SAD operation of each macroblock subsequently increases when a macroblock changes. While the SAD operation is performed on the first portion of a macroblock, simultaneously the update of a predetermined sub-memory among sub-memories of the second memory 150, which are used in the SAD operation of the last portion of the macroblock, is performed. As a result, execution time for the SAD operation can be reduced.

When the SAD operation is performed on the second macroblock of the first pattern, the memory count is incremented from 3 to 5. When the memory count is 3, the second and third sub-memories MEM2 and MEM3 are used. When the memory count is 4, the third and fourth sub-memories MEM3 and MEM4 are used. When the memory count is 5, the fourth and first sub-memories MEM4 and MEM1 are used. When the memory count is 3, the update of the first sub-memory MEM1 which will be used when the memory count is 5 is performed. This means that the SAD operation on a part of a macroblock and the update of memory corresponding to another part of the macroblock can be performed simultaneously. However, when the memory count is 4 or 5, a sub-memory update is not performed.

The calculator 110 includes an operation unit block 111 and a comparison unit 116. The operation unit block 111 includes a plurality of operation units each for performing a block matching algorithm with respect to the first image data DATAL and the second image data DATA2 of a block among a plurality of blocks in a search range. The comparison unit 116 compares block matching results output from the operation unit block 111 with each other and determines an optimal matching block. The block matching algorithm may be an algorithm performing a SAD operation.

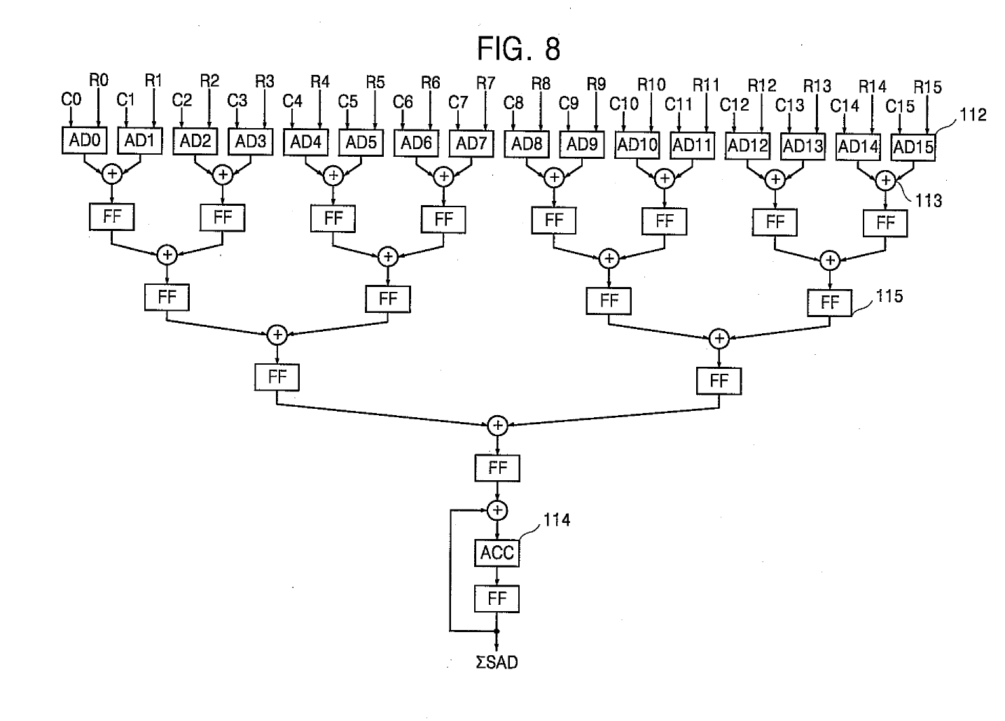

FIG. 8 illustrates the pipe line structure of an operation unit included in the operation unit block 111 and performing a SAD operation with respect to a 16×8 macroblock according to one embodiment of the invention. Referring to FIG. 8, the operation unit includes a plurality of SAD operators 112 (ADx where x=0, 1, 2, . . . , 15), a plurality of adders 113, and an accumulator 114.

Each of the SAD operators 112 performs the SAD operation with respect to the first image data DATAL and a corresponding part of the second image data DATA2. A reference character Cx (where x=0, 1, 2, . . . , 15) denotes the first image data DATAL of a pixel in the macroblock and a reference character Rx (where x=0, 1, 2, . . . , 15) denote the second image data DATA2 of a pixel in a search range. The SAD operators 112 can simultaneously perform the SAD operation on 16 pixels. The SAD operators 112 performs the SAD operation on 16 pixels eight times, thereby performing the SAD operation on the 16×8 macroblock, which is a vertical extension.

The adders 113 sum a plurality of SAD values. The accumulator 114 accumulates SAD operation results and outputs an accumulated value. For instance, the accumulator 114 accumulates eight SAD operation results with respect to an exemplary 16×8 macroblock.

Each operation unit may further include a plurality of time delay elements 115 for securing an operating margin of the respective adders 113 and/or a time delay element 115 for securing an operating margin of the accumulator 114. Each time delay element 115 may be a flip-flop. When it takes one clock for each SAD operation 112 to perform the SAD operation on a single pixel and the delay time of the flip-flop 115 is one clock, it takes 13 clock cycles to perform the SAD operation in relation to the 16×8 macroblock. That is, execution of the SAD operation on 16 pixels is performed in the horizontal direction during one clock. Since eight repetitions of the SAD operation are required in the vertical direction, it takes 8 clock cycles for the SAD operation. When the flip-flops 115 delay time on five stages and each flip-flop 115 delays one clock, five clocks are delayed by the flip-flops 115. As a result, a total of 8+5 or 13 clock cycles are taken for the SAD operation to be executed in relation to the 16×8 macroblock.

In the image processing device 100, when a plurality of operation units are arrayed in the horizontal direction in the operation unit block 111, a range on which the SAD operation is performed can be extended in the horizontal direction.

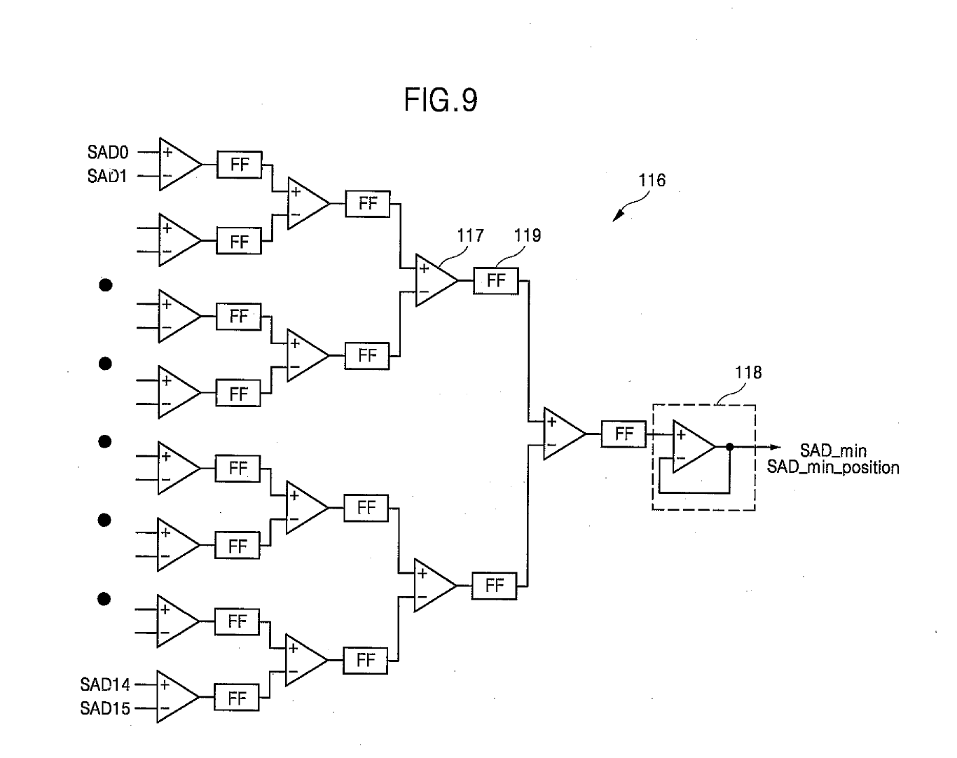

FIG. 9 illustrates the comparison unit 116 included in the image processing device 100 illustrated in FIG. 3. The comparison unit 116 includes a plurality of comparators 117 and a buffer 118. The comparators 117 compare SAD operation values SAD0 through SAD15 output from the plurality of operation units and output a minimum SAD operation value SAD_min and an optimal matching block position SAD_min_position. The buffer 118 buffers the minimum SAD operation value SAD_min. The comparison unit 116 may further include a plurality of time delay elements 119 each for securing an operating margin of a corresponding one among the comparators 117. Each time delay element 119 may be a flip-flop.

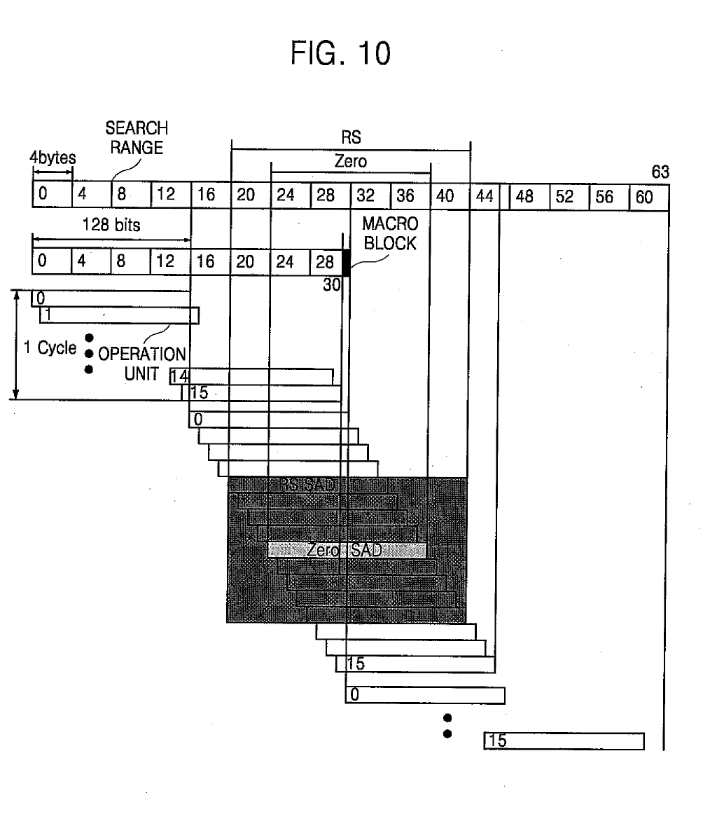

FIG. 10 is a conceptual diagram further illustrating a method of sharing data in a horizontal direction using an operation unit block including 16 operation units according to the illustrated embodiments of the invention. In FIG. 10, numerals 0, 4, . . . , 60 in the top row denote pixels arrayed in the horizontal direction of a search range and numerals 1, 4, . . . , 28 in the next row denote pixels of a macroblock. Image data of each pixel is 8 bits in length and image data of 16 pixels is 128 bits in length.

Referring to FIG. 10, 16 operation units are used to perform a SAD operation with respect to 32 pixels during one clock cycle. A total of 8 clock cycles is required to perform the SAD operation with respect to the 16×8 macroblock. Here, time delay for the flip-flops illustrated in FIG. 8 is not considered. However, since SAD operations on 16 macroblocks are simultaneously performed by the 16 operation units, the SAD operation for all 16 macroblocks may be completed in 8 clock cycles.

The image processing device 100 according to embodiments of the invention may be implemented using various algorithms by performing the SAD operation in relation to particular positions in a search range. For instance, as illustrated in FIG. 10, the image processing device 100 can perform refinement search (RS) and zero search (ZS). RS is a process of performing a block matching algorithm on a predetermined search range narrowed around a position of a previous MV and ZS is a process of performing the block matching algorithm on a block of a previous frame corresponding to a position of a macroblock.

An image processing device according to an embodiment of the invention may be used for electronic devices such as cameras, scanners, and camcorders which acquire and process images; electronic devices such as computers which store and process images; and electronic devices such as monitors and printers which output images.

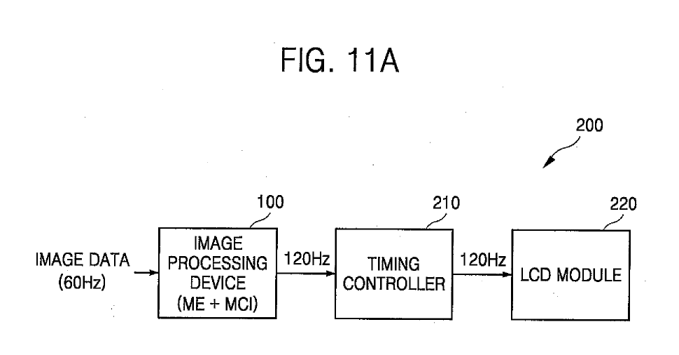

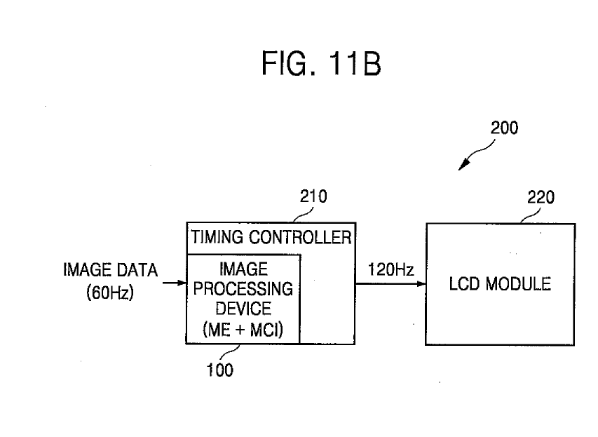

FIGS. 11A and 11B are block diagrams of a display device 200 using the image processing device 100 according to an embodiment of the invention. Referring to FIGS. 11A and 11B, the display device 200 includes the image processing device 100, a timing controller 210, and a liquid crystal display (LCD) module 220. As illustrated in FIG. 11B, the image processing device 100 and the timing controller 210 may be implemented on a single chip.

The image processing device 100 receives image data having a frequency of 60 Hz and converts it into 120-Hz image data through motion estimation (ME) and motion compensated interpolation (MCI). The timing controller 210 generates a control signal for driving the LCD module 220 based on the 120-Hz image data and outputs the 120-Hz image data to the LCD module 220. The LCD module 220 displays an image at the frequency of 120 Hz in response to the control signal. In embodiments of the invention, the image processing device 100 may be used to increase a frame rate at which the image is displayed.

Digital broadcasting systems used in South Korea and the United States, for example, transmit images at a frame rate of 60 per second (60 Hz). That is, 60 image frames are broadcasted each second. The display device 200 according to embodiments of the invention inserts a new image frame between image frames transmitted at the 60 Hz frame rate and transfers 120 image frames per second, thereby remarkably reducing the problem of motion blur and jitter occurring in conventional display devices using LCD.

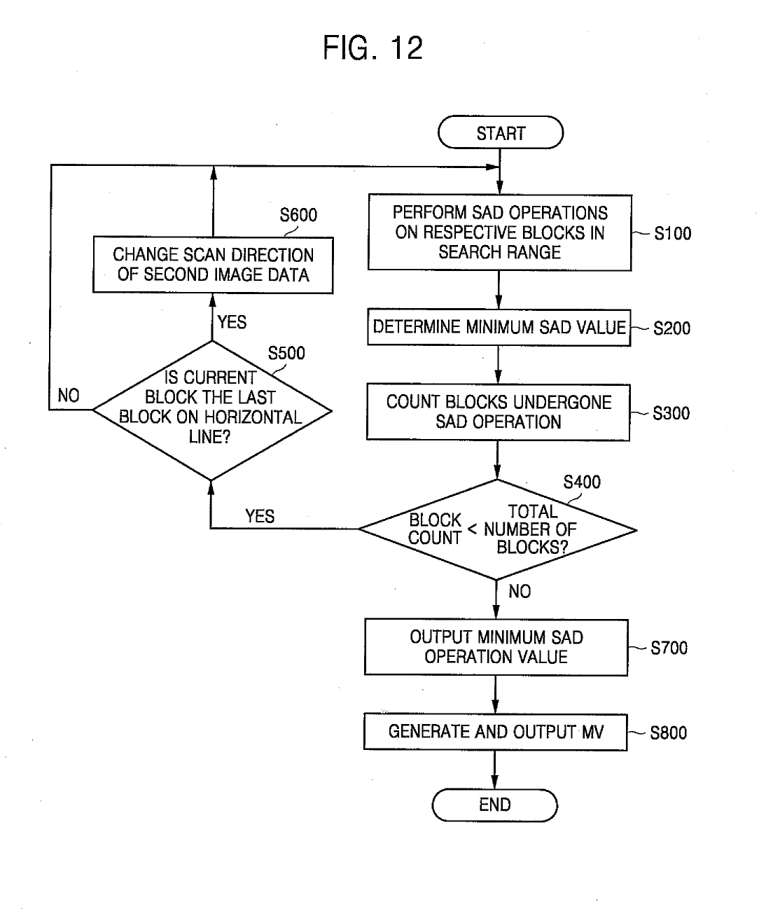

FIG. 12 is a flowchart summarizing a method of performing a block matching algorithm with respect to an entire predetermined search range using the image processing device 100 according to an embodiment of the invention. In the method illustrated in FIG. 12, a SAD operation is used as a block matching algorithm, but the present invention is not restricted thereto. The image processing method will be described in detail with reference FIGS. 3, 10, and 12 below.

The operation unit block 111 performs SAD operations in parallel on the first image data DATAL of a macroblock and the second image data DATA2 of 16 blocks in the search range (S100). The comparison unit 116 determines a block having a minimum value among SAD operation values resulting from the SAD operations (S200).

The controller 120 counts blocks that have undergone the SAD operation (S300). The controller 120 then determines whether all blocks in the search range have undergone the SAD operation (S400). When it is determined that all blocks in the search range have undergone the SAD operation (S400=no), the comparison unit 116 outputs the minimum SAD operation value SAD_min (S700) and the controller 120 outputs an MV based on the minimum SAD operation value SAD_min (S800).

However, when it is determined that all blocks in the search range have not undergone the SAD operation (S400-yes), the controller 120 determined whether the SAD operation on the last block of a horizontal line has been performed (S500). When it is determined that the SAD operation on the last block of the horizontal line has been performed, the controller 120 changes the scan direction of the second image data DATA2 opposite to a previous scan direction (S600). When it is determined that the SAD operation on the last block of the horizontal line has not been performed, the controller 120 maintains the scan direction of the second image data DATA2.

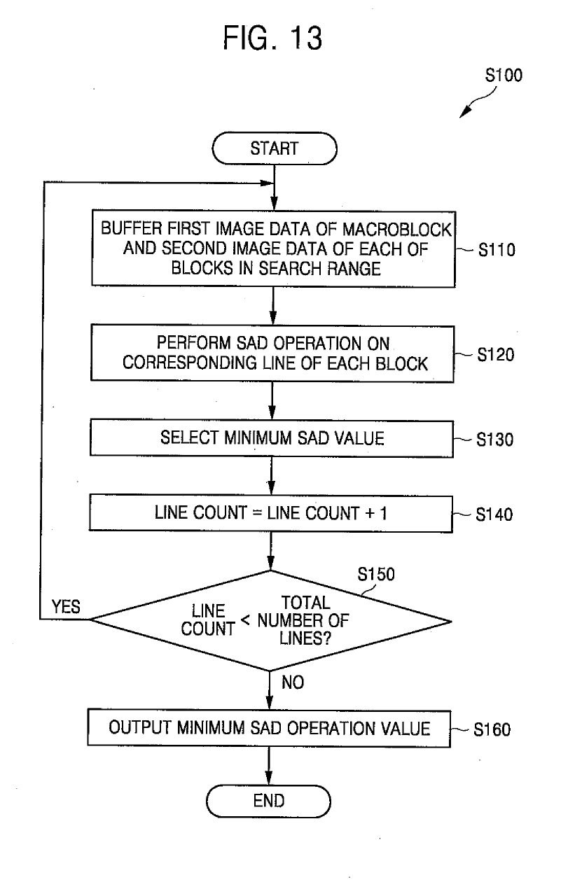

FIG. 13 is a flowchart summarizing a method of performing a SAD operation with respect to a plurality of blocks in a search range using the image processing device 100 according to an embodiment of the invention. The method illustrated in FIG. 13 will be described in detail with reference to FIGS. 3, 10, and 13 below.

The memory controller 130 generates the first control signal CS1 and the second control signal CS2 in response to the ME enable signal EN_ME received from the controller 120. The first memory 140 buffers the first image data DATAL in response to the first control signal CS1 and the second memory 150 buffers the second image data DATA2 in response to the second control signal CS2 (S110).

The operation unit block 111 performs the SAD operation on the first image data DATAL and the second image data DATA2 (S120). The operation unit block 111 includes a plurality of operation units and each of the operation units performs the SAD operation on a corresponding line among a plurality of lines in a macroblock.

When (e.g.) the macroblock is 16×8 pixels in size, the operation unit block 111 may include 16 operation units, which can simultaneously perform the SAD operations on 16 macroblocks, respectively. The comparison unit 116 compares SAD values resulting from the SAD operations of the respective operations units and selects a minimum SAD value (S130).

The controller 120 controls to buffer the second image data DATA2 of a line of a block in the search range, which corresponds to a next line of the macroblock (S140). The controller 120 then determines whether the SAD operation has been performed with respect to all lines of the macroblock (S150). When the macroblock is 16×8 pixels in size, the controller 120 determines whether the SAD operation on the eighth line in the vertical direction of the macroblock has been performed. When it is determined that the SAD operation has been performed on all lines of the macroblock (S150=no), the comparison unit 116 outputs the minimum SAD operation value SAD_min (S160). Otherwise, the SAD operation is performed on a next line of the macroblock (return to S110).

The image processing method according to embodiments of the invention may be implemented in hardware, software, firmware, or combinations thereof. When the method is embodied in software, it may be embodied as computer readable codes or programs stored on a computer readable recording medium. The computer readable recording medium may be any data storage device capable of storing data that may be read by a computer system. Examples of the computer readable recording medium include read-only memory (ROM), random-access memory (RAM), electrically erasable programmable ROM (EEPROM), and flash memory.

According to the present invention, data used for motion estimation is shared, allowing efficient memory management and minimizing a memory update during data scan. In addition, memory is updated while a block matching algorithm is being performed, so that an image processing speed is increased. Furthermore, according to embodiments of the invention, an operation range can be extended in the horizontal and vertical directions when a search range is increased.

While the present invention has been particularly shown and described with reference to exemplary embodiments thereof, it will be understood by those of ordinary skill in the art that various changes in forms and details may be made therein without departing from the scope of the present invention as defined by the following claims.

What is claimed is:

1. An image processing device comprising:
a calculator configured to perform a block matching algorithm based on a difference between first image data of a macroblock and second image data of each of a plurality of blocks in a search range; and
a controller configured to generate a motion vector used for motion compensation based on a result of the block matching algorithm and change a scan direction associated with the second image data at a defined interval.

2. The image processing device of claim 1, wherein the defined interval is one horizontal period for a frame.

3. The image processing device of claim 2, further comprising:
a memory controller configured to generate a first control signal and a second control signal in response to a motion estimation enable signal received from the controller;
a first memory configured to buffer the first image data received from a video memory in response to the first control signal; and
a second memory configured to buffer the second image data received from the video memory in response to the second control signal.

4. The image processing device of claim 3, wherein the controller divides the second memory into a plurality of sub-memories having a predetermined size and sequentially updates the second image data with respect to the plurality of sub-memories.

5. The image processing device of claim 4, wherein the controller divides the search range into a plurality of sub-ranges having a predetermined size and scans the second image data in each sub-range in a direction orthogonal to the scan direction associated with the second image data in the frame.

6. The image processing device of claim 5, wherein the controller updates at least one sub-memory of the second memory corresponding to a sub-range in which the second image data has been completely scanned among the plurality of sub-ranges and simultaneously performs the block matching algorithm with respect to a subsequent sub-range among the plurality of sub-ranges.

7. The image processing device of claim 6, wherein the calculator comprises:
an operation unit block comprising a plurality of operation units configured to perform the block matching algorithm with respect to the first image data and the second image data of each of the plurality of blocks; and
a comparison unit configured to compare block matching algorithm results output from the operation unit block and determine an optimal matching block.

8. The image processing device of claim 7, wherein each of the operation units comprises:
a plurality of operators configured to obtain absolute values of differences between the first image data and the second image data;
a plurality of adders configured to obtain a sum of the absolute values of the differences; and
an accumulator configured to accumulate results of a sum absolute difference (SAD) operation repeated a plurality of times based on a size of the macroblock and output a SAD operation value.

9. The image processing device of claim 8, wherein each of the operation units further comprises a plurality of time delay elements to secure respective operating margins for at least one of the plurality of adders and the accumulator.

10. The image processing device of claim 8, wherein the comparison unit comprises:
a plurality of comparators configured to compare SAD operation values output from the respective operation units and select a minimum SAD operation value; and
a buffer configured to buffer the minimum SAD operation value.

11. The image processing device of claim 10, wherein the comparison unit further comprises a plurality of time delay elements to secure operating margins of the respective comparators.

12. A display device comprising:
an image processing device configured to receive first image data at a first frame frequency, convert the image date to a second frame frequency greater than the first frame frequency using motion estimation and motion compensation processes;
a timing controller configured to generate second image data at the second frame frequency and a corresponding control signal; and
a liquid crystal display (LCD) module responsive to the control signal and displaying the second image data,
wherein the image processing device comprises:
a calculator configured to perform a block matching algorithm based on a difference between first image data of a macroblock and second image data of each of a plurality of blocks in a search range associated with the first image data; and
a controller configured to generate a motion vector used for motion compensation based on a result of the block matching algorithm and change a scan direction associated with the second image data at a defined interval.

13. An image processing method comprising:
performing a block matching algorithm based on a difference between first image data of a macroblock and second image data of each of a plurality of blocks in a search range; and
generating a motion vector used for motion compensation based on a result of the block matching algorithm and changing a scan direction for the second image data at an interval of one horizontal period in a frame.

14. The image processing method of claim 12, further comprising:
generating a first control signal and a second control signal in response to a motion estimation enable signal;
buffering the first image data received from a video memory in response to the first control signal; and
buffering the second image data received from the video memory in response to the second control signal.

15. The image processing method of claim 14, wherein buffering the second image data comprises dividing a second memory buffering the second image data into a plurality of sub-memories having a predetermined size and sequentially updating the second image data with respect to the plurality of sub-memories.

16. The image processing method of claim 14, wherein buffering the second image data further comprises dividing the search range into a plurality of sub-ranges having a predetermined size and scanning the second image data in each sub-range in a direction orthogonal to the scan direction for the second image data.

17. The image processing method of claim 16, further comprising updating at least one sub-memory of the second memory corresponding to a sub-range in which the second image data has been completely scanned among the plurality of sub-ranges and simultaneously performing the block matching algorithm with respect to a subsequent sub-range among the plurality of sub-ranges.

18. The image processing method of claim 17, wherein performing the block matching algorithm based on the difference between the first image data and the second image data comprises:
performing the block matching algorithm with respect to the first image data and the second image data of each of the plurality of blocks; and
determining an optimal matching block through comparison between block matching algorithm results.

19. The image processing method of claim 18, wherein performing the block matching algorithm with respect to the first image data and the second image data comprises:
obtaining absolute values of differences between the first image data and the second image data;
obtaining a sum of the absolute values of the differences; and
accumulating results of a sum absolute difference (SAD) operation repeated a plurality of times based on a size of the macroblock and outputting a SAD operation value.

20. The image processing method of claim 19, wherein obtaining the sum of the absolute values comprises applying a delay time sufficient to secure a temporal margin for summing the absolute values.

21. The image processing method of claim 19, wherein determining the optimal matching block comprises:
comparing SAD operation values and selecting a minimum SAD operation value; and
buffering the minimum SAD operation value.

22. The image processing method of claim 21, wherein the determining the optimal matching block further comprises applying a delay time sufficient to secure a temporal margin for comparing the SAD operation values.
